(19) United States
(12) Patent Application Publication
(10) Pub. No.: US 2025/0011171 A1
(43) Pub. Date: Jan. 9, 2025

(54) MONO PRESSURE SYSTEM FOR PRODUCING NITRIC ACID AND METHOD OF OPERATING THEREOF

(71) Applicant: YARA INTERNATIONAL ASA, Oslo (NO)

(72) Inventors: Bent VIGELAND, Skien (NO); Halvor ØIEN, Porsgrunn (NO); Krzysztof BANASIAK, Trondheim (NO); Andre DE SMET, Terneuzen (NL); Peter FAUCONNIER, Grimbergen (BE)

(21) Appl. No.: 18/292,739

(22) PCT Filed: Aug. 25, 2022
(86) PCT No.: PCT/EP2022/073640

§ 371 Date: Jan. 26, 2024

(30) Foreign Application Priority Data
Aug. 25, 2021 (EP) 21193034.2
Jan. 11, 2022 (EP) 22150921.9
Mar. 3, 2022 (EP) 22160045.5

(51) Int. Cl. C01B 21/40; B01D 53/14; B01D 53/56; B01D 53/78; C01B 21/28; C01B 21/46; F01K 23/06

(52) U.S. Cl. CPC C01B 21/40; B01D 53/1493; B01D 53/56; B01D 53/78; C01B 21/28; C01B 21/46; F01K 23/06; B01D 2252/103; B01D 2257/404

(57) ABSTRACT

A production plant for producing nitric acid at reduced power, the system derived from a state-of-the art mono pressure nitric acid plant wherein the system further includes a first feature for splitting a tail gas stream into a first tail gas stream in fluid communication with an oxygen-rich gas and with compressed air and a second tail gas stream, and/or a second feature for splitting a tail gas stream into a third tail gas stream in fluid communication with an oxygen-rich gas and with compressed air and a fourth tail gas stream, a feature for pressurizing a gas downstream the absorption tower. The production plant allows for reduction of power by the air compressor. A method for operating the system, the use of the system for performing the method of the disclosure, and a method for revamping a state-of-the art mono pressure nitric acid plant into the system.

### FIELD

The present disclosure relates to the field of nitric acid production in a mono pressure plant.

### BACKGROUND

Pure nitric acid is a clear, colorless liquid with a strong odor. Nitric acid is produced in large quantities principally by catalytic oxidation of ammonia (Ostwald process). Ammonia is converted to nitric acid in several stages. Ammonia is first oxidized in an ammonia burner on platinum gauzes (commonly called ammonia converter) or cobalt balls, producing nitric oxide (in this disclosure also called nitrogen monoxide (NO)) and water:

4NH₃(g)+5O₂(g)→4NO(g)+6H₂O(g) (1)

The reaction product from (1), nitric oxide, following cooling, is then oxidized to nitrogen dioxide (NO₂) and further to dinitrogen tetroxide N₂O₄(g) in an oxidation section:

2NO(g)+O₂(g)→2NO₂(g) (2)

2NO₂(g)→N₂O₄(g) (3)

Cooling of nitrogen oxide gases is accomplished first through the use of a waste heat recovery system recovering the heat from the conversion of ammonia into nitric oxide, then through the use of a cooler condenser in which condensed nitric acid is separated from nitric oxide, nitrogen dioxide and dinitrogen tetroxide and nitric acid gases, collectively called NOₓ gases, and finally by heating the tail gas released at the outlet of the absorption tower in which the NOₓ gases are absorbed.

By absorption in water, nitrogen dioxide and dinitrogen tetroxide are converted to nitric acid and nitric oxide:

3NO₂(g)+H₂O(l)→2HNO₃(aq)+NO(g) (4)

3N₂O₄(g)+2H₂O(l)→4HNO₃(aq)+2NO(g) (5)

Weak nitric acid which is up to 68% (azeotrope) is obtained. Through a rectification process the concentration of nitric acid can be increased up to 99% concentrated nitric acid. The total reaction is given by the following formula:

NH₃+2O₂→HNO₃+H₂O (6)

The main process units in a nitric acid production plant, include an ammonia converter (conversion of ammonia into nitric oxides using oxygen over a suitable catalyst), an oxidation section (conversion of nitric oxide into nitrogen dioxide and nitrogen tetroxide), an absorber unit (for the absorption of NOₓ gases into water) and a bleacher unit (removal of unreacted dissolved gases, containing in particular NOₓ and gases, from the aqueous nitric acid solution, which give it its typical brownish color).

The process for the production of nitric acid can be differentiated into a mono-pressure (single-pressure) and dual pressure (split-pressure) process.

In a mono-pressure process, the converter and the absorber unit operate at roughly the same working pressure. Such mono-pressure process generally includes low-pressure processes, typically operating from 2 to 6 bara, and high-pressure processes, typically operating from above 6 to 16 bara, in particular from 9 to 16 bara.

The drive power for the air compressor typically originates from a tail-gas turbine and a steam turbine or electric motor. Accordingly, the compressor train of mono pressure nitric acid production plant typically comprises an air compressor, a tail-gas turbine, and a steam turbine or electric motor.

More in detail, referring to FIG. 1, a mono pressure plant and process according to the prior art works as follows. Gaseous ammonia 32, optionally pre-heated in a pre-heater unit (not shown) is mixed with compressed air 34 pressurized using an air compressor 36, in a mixing apparatus 35, and the resulting ammonia/(oxygen-enriched) air mixture 14 is fed to an ammonia converter 37, where ammonia is oxidized over a suitable catalyst, thus obtaining a NOₓ gas/steam mixture 15, comprising water and nitric oxide (NO). The heat of the mixture coming out of the ammonia converter is recovered, after which the NOₓ gas/stream mixture is subsequently cooled down in a gas cooler/condenser 38 to a temperature where the water condenses, and an aqueous diluted nitric acid mixture 17 is separated from a gaseous NOₓ stream 22. The gaseous NOₓ stream is further oxidized to further convert the NO to NO₂ and N₂O₄ to separate out another aqueous diluted nitric acid mixture 17 which is directed to an absorption tower 41, commonly called absorption tower. On the other end, the gaseous NOₓ stream 22 is sent to the absorber unit 41 too. Inside the absorber unit 41, the NOₓ gas reacts with water to produce the tail gas 5 and a stream of raw nitric acid 27 also containing residual NOₓ gas, which is fed to a bleacher 57. The residual NOₓ gas in the raw nitric acid stream 27 is then stripped out with a gaseous medium 60 such as an oxygen-containing gas or air, inside the bleacher 57; the bleacher unit is generally operated at about the same pressure as the ammonia converter. The drive power for the air compressor 36 originates from a tail gas expander 7 and a steam turbine 51 or electric motor (not shown). The tail gas 5 exchanges heat with the NOₓ gas/steam mixture 15 in the tail gas heater 43 and is further expanded in the tail gas expander 7.

The air used for the oxidation of ammonia is commonly denoted as primary air; the air used as stripping medium in the bleacher unit is commonly denoted as secondary air.

According to the prior art, the revamping of the nitric acid production plants to increase its capacity is commonly based on increasing the amount of primary air to the reactor, which leads to a proportional increase of the amount of nitric acid produced.

The increase of the amount of primary air in the reactor entails the installation of a new air compressor or the revamping of the existing one. This revamping has significant drawbacks. First of all, it entails elevated costs for the modification or replacement of the existing equipment, i.e. the air compressor and the corresponding turbines and electrical motor. In addition, the revamping of the equipment is also technically demanding, leading to long plant downtime.

Another problem related to nitric acid production plants is the high amount of energy required in order to operate the air compressor. Consequently, a high amount of energy is required to achieve the targeted nitric acid production throughput.

A goal of the present invention, therefore, is to provide a system and a method for operating the system which allows for the reduction or even suppression of power required to operate the air compressor in a mono nitric acid plant.

In CN110540178A (China Chengda Engineering Co Ltd, 2019), a process for producing nitric acid is disclosed. Nitric acid is produced by a medium pressure method, which is characterized in that it comprises the following steps: the ammonia oxidation and absorption pressure is 0.5-0.6 MPa; enabling the tail gas leaving the absorption tower to pass through a carbon molecular sieve Temperature Swing Adsorption (TSA) treatment device to reduce the content of nitrogen oxides in the tail gas to be less than 100 mg/Nm³; the process air of the air compressor is used as the regeneration desorption gas of the carbon molecular sieve temperature swing adsorption treatment device, and the regeneration desorption gas containing the nitrogen oxide can be returned to the ammonia oxidation reactor for reuse; adding a layer of N₂O decomposition catalyst in the oxidation reactor to reduce the content of N₂O to 50-100 ppm through reaction; the nitric acid bleaching tower is arranged at the bottom of the absorption tower, and the two towers are integrated, so that the process flow is shortened, and the equipment investment is reduced. With regard to the amount of air being compressed by the air compressor, however, the same amount of air is to be compressed as would be in the absence of the TSA unit: in the presence of the TSA unit, the amount of air being compressed is initially split between the TSA unit and the ammonia oxidation reactor directly and, in the end, with the amount of compressed air leaving the TSA unit being directed also to the ammonia oxidation reactor, the total amount of air compressed by the air compressor ends up in the ammonia oxidation reactor.

In WO2018/162150A1 (Casale SA, 13 Sep. 2018) a solution is proposed to overcome the revamping drawbacks. WO2018162150A1 discloses a dual pressure plant for the production of nitric acid comprising a reactor providing a gaseous effluent containing nitrogen oxides, an absorber unit in which nitrogen oxides react with water providing raw nitric acid and, the absorber unit operating at a pressure greater than the pressure of the reactor, a compressor elevating the pressure of the reactor effluent to the absorber unit pressure, the plant also comprising a first high-pressure (HP) bleacher unit and a second low-pressure (LP) bleacher unit, the first HP bleacher unit stripping with air the NOₓ gas from the output stream of the absorber unit, thus providing a partially stripped nitric acid stream and a nitrogen oxides-loaded air stream, the former being fed to the second LP-bleacher unit and the latter being recycled to the oxidation section, upstream of the NOₓ gas compressor. A further air compressor is also provided, which supplies the first HP bleacher unit with air. Hence, energy is required in order to operate a first HP bleacher unit at a high-pressure and then recycle NOₓ gases to the delivery side of the NOₓ gas compressor.

Therefore, there remains a need for a process and a corresponding plant setup for minimizing or even suppressing the amount of energy required in order to operate the air compressor, in order to avoid bottle-necks in the nitric acid production throughput associated with those compressors.

### SUMMARY

In one aspect of the disclosure, a production plant for producing nitric acid at reduced power consumption and reduced emissions is disclosed. The production plant comprises:
an air compressor providing compressed air;
a supply for an oxygen-rich gas, such as a high-pressure water electrolyzer, the oxygen-rich gas being in fluid communication with compressed air, the mixing of the oxygen-rich gas and of compressed air providing part of a first oxygen-containing gas;
a mixing apparatus, for mixing the first oxygen-containing gas with an ammonia gas stream, to produce an ammonia/oxygen-containing gas mixture;
an ammonia converter operable at a pressure P1, for oxidising ammonia in the ammonia/oxygen-containing gas mixture, to produce a NOₓ gas/steam mixture comprising water and nitric oxide;
a means for regulating the concentration of ammonia and/or of oxygen in the ammonia converter, particularly a means for controlling the flow of the oxygen-rich gas and/or a means for controlling the flow of the ammonia gas stream, for maintaining the oxygen to ammonia molar ratio inside the ammonia converter at a ratio of at least 1.2, in particular between 1.2 and 9;
a gas cooler/condenser downstream the ammonia converter, to produce an aqueous diluted nitric acid mixture and a gaseous NOₓ stream;
an absorption tower, downstream the gas cooler/condenser, for absorbing the NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas; and
a supply for a second oxygen-containing gas, for supplying oxygen to a NOₓ gas containing stream between the ammonia converter and the absorption tower, such that a tail gas stream contains at least 0.5% by volume oxygen;
a tail gas heater, positioned upstream from the gas cooler/condenser, for heating a tail gas stream with the heat from the NOₓ gas/steam mixture coming from the ammonia converter.
   The production plant is characterized in that it further comprises:
a first and/or second means for splitting a gas stream wherein:
   (i) the first means for splitting is a means for splitting a tail gas stream into a first tail gas stream and a second tail gas stream, and wherein the first tail gas stream is in fluid communication with the oxygen-rich gas and compressed air, and wherein the mixing of compressed air, the first oxygen-rich gas and the first tail gas stream provides the first oxygen-containing gas; and
   (ii) the second means for splitting is a means for splitting a tail gas stream into a third tail gas stream and a fourth tail gas stream, and wherein the third tail gas stream is in fluid communication with compressed air and with the oxygen-rich gas, and wherein the mixing of compressed air, the oxygen-rich gas and the third tail gas stream provides at least partly the second oxygen-containing gas; and
a means for pressurizing a gas, located downstream the absorption tower, or between the ammonia converter and the absorption tower, or upstream the ammonia converter in the first oxygen-containing gas or in the ammonia/oxygen-containing gas mixture, to provide the first and/or the third tail gas stream at a pressure P1.

The inventors have found that, instead of supplying primary and secondary air solely as compressed air provided by an air compressor, it is possible to recirculate the first tail gas stream and/or the third tail gas stream, provided by the first means for splitting and the second means for splitting, respectively. The oxygen-rich gas having a pressure P1 and the second oxygen-containing gas provide oxygen to the ammonia converter and to the absorption tower, respectively, such that, even at reduced amounts of compressed air provided by the air compressor, the concentration of oxygen in the ammonia converter and in the absorption tower is at least equal to that in a state-of-the-art mono pressure nitric acid plant.

Therefore, tail gas, particularly with controlled oxygen content, can be recirculated both as primary and secondary air. Consequently, less compressed air is to be supplied such that less air has to be compressed and the power demand on the air compressor is reduced. At the same time, the size of the air compressor and that of a conventional gas expander, in which the tail gas is expanded in a state-of-the-art mono pressure nitric acid plant, are reduced, such that the footprint of the plant is reduced. Furthermore, the NOₓ emissions leaving the production plant are also reduced. Consequently, the size of the treatment unit for treating those NOₓ emissions is reduced with respect to the size in the corresponding state-of-the art mono pressure nitric acid plant. Also, the separate supply of the pressurized oxygen or oxygen-rich gas ensures an optimal conversion of ammonia to nitric oxide.

In one embodiment according to the production plant of the disclosure, the production plant further comprises a means for controlling the flow of the first and/or the third tail gas stream.

In one embodiment according to the production plant of the disclosure, the production plant further comprises one or more of:
a heat exchanger, for exchanging heat between a tail gas stream downstream the absorption tower and the stream of heated tail gas exiting the tail gas heater, particularly for exchanging heat between a heated tail gas stream downstream the tail gas heater and a stream of tail gas upstream the tail gas heater, wherein:
   (i) the tail gas stream having exchanged heat with the stream of heated tail gas, particularly the heated tail gas stream downstream the tail gas heater and having exchanged heat with the stream of tail gas upstream the tail gas heater, is supplied to or in direct fluid communication with the first means for splitting downstream the heat exchanger, and wherein the means for pressurizing is located upstream the heat exchanger; and/or
   (ii) the tail gas at the outlet of the absorption tower is split into a third tail gas stream and a fourth tail gas stream;
a De-NOₓ treatment unit; and
a steam turbine, wherein the steam turbine can at least partly power the means for pressurizing.

In one embodiment according to the production plant of the disclosure, the production plant further comprises a bleacher comprising an inlet for an oxygen-rich bleaching gas, an inlet for the stream of raw nitric acid containing residual NOₓ gas, an outlet for bleached nitric acid and an outlet for off-gases, wherein the off-gases are in fluid communication with a gas stream between the ammonia converter and the absorption tower, such that the second oxygen-containing gas comes at least partly from the off-gases.

In one embodiment according to the production plant of the disclosure, the oxygen-rich gas, the second oxygen-containing gas, the oxygen-rich bleaching gas and the oxygen-rich off-gases are provided at least partly by a high-pressure water electrolyzer.

In one embodiment according to the production plant of the disclosure, the production plant further comprises a tail gas expander for expanding the second tail gas stream to atmospheric pressure, to produce an expanded tail gas, wherein the means for pressurizing can be powered at least partly by the tail gas expander or by the steam turbine or by a power source.

In one aspect of the disclosure, a method for producing nitric acid at reduced power consumption and reduced emissions, in a production plant according to the production plant of the disclosure is disclosed. The method comprises the steps of:
a) compressing air in the air compressor, thereby providing compressed air;
b) supplying compressed air obtained in step a) to the mixing apparatus;
c) supplying the ammonia gas stream to the mixing apparatus, thereby producing the ammonia/oxygen-containing gas mixture;
d) oxidising ammonia in the ammonia/oxygen-containing gas mixture in the ammonia converter at a pressure P1, thereby producing the gaseous NOₓ gas/steam mixture comprising water and nitric oxide;
e) separating and condensing steam in the gas cooler/condenser, thereby generating the aqueous diluted nitric acid mixture and the gaseous NOₓ stream;
f) absorbing the gaseous NOx stream in the absorption tower, thereby producing the stream of raw nitric acid containing residual NOx gas and the tail gas comprising NOx gases; and
g) heating the tail gas in the tail gas heater, particularly to a temperature up to 650° C., with the gaseous NOₓ gas/steam mixture.
   The method is characterized in that it further comprises the steps of:
h) pressurizing a gas stream located downstream the absorption tower, or anywhere between the ammonia converter and the absorption tower, or upstream the ammonia converter in the first oxygen-containing stream or in the ammonia/oxygen-containing gas mixture, to a pressure P1 with the means for pressurizing;
i) splitting a tail gas stream, particularly a stream of tail gas downstream the absorption tower, with the first means for splitting into the first tail gas stream and the second tail gas stream and/or with the second means for splitting into the third tail gas stream and the fourth tail gas stream;
j) mixing the first tail gas stream with the oxygen-rich gas and compressed air, thereby providing the first oxygen-containing gas, and/or mixing the third tail gas stream with the oxygen-rich gas and compressed air, thereby providing at least partly the second oxygen-containing gas;
k) adjusting the flow of the oxygen-rich gas being mixed in step j) or the flow of the ammonia gas stream in step c), such as to maintain the oxygen to ammonia molar ratio inside the ammonia converter at a ratio of at least 1.2, particularly between 1.2 and 9;
l) supplying the first oxygen-containing gas to the mixing unit;
m) adjusting the flow of the second oxygen-containing gas, such that a tail gas stream contains at least 0.5% by volume oxygen; and
n) supplying the second oxygen-containing gas.

In one embodiment according to the method of the disclosure, the method further comprises the step of:
o) adjusting the flow of the first and/or the third tail gas stream.

In one embodiment according to the method of the disclosure, in step h), the tail gas obtained from step f) is pressurized in the means for pressurizing, and in step i), the tail gas stream is split into a first tail gas stream and a second tail gas stream, or stated differently, step h) is performed before step i), and the method further comprises the steps of:
p) after step f) and before step g), heating the tail gas with the tail gas to be split in step i), in the heat exchanger, thereby bringing the tail gas to be mixed in step j) to a temperature below 300° C.;
q) treating the tail gas in the De-NOₓ treatment unit before step g) and after step p); and
r) recovering at least part of the heat energy generated in the ammonia converter in a steam turbine.

In one embodiment according to the method of the disclosure, in step h), the tail gas obtained from step f) is pressurized in the means for pressurizing, and in step i), the pressurized tail gas obtained from step h) is split into a third tail gas stream and a fourth tail gas stream.

In one embodiment according to the method of the disclosure, the method further comprises the step of:
s) bleaching the stream of raw nitric acid containing residual NOₓ gas obtained in step f) in the bleacher, thereby producing the bleached nitric acid.

In one embodiment according to the method of the disclosure, the method further comprises the steps of:
t) operating the high-pressure water electrolyzer, thereby producing pressurized oxygen; and
u) providing, from the oxygen produced by the water electrolyzer in step t), at least part of the oxygen-rich gas, the second oxygen-containing gas, the oxygen-rich bleaching gas and the oxygen-rich off-gases.

In one embodiment according to the method of the disclosure, the method further comprises the step of:
v) expanding the second tail gas stream in the tail gas expander to atmospheric pressure, thereby producing the expanded tail gas.

In one aspect of the disclosure, the use of the production plant of the disclosure for performing the method of the disclosure, is disclosed.

In one aspect of the disclosure, a method for revamping a production plant for producing nitric acid, wherein the existing production plant comprises:
an air compressor for providing compressed air;
a mixing apparatus for mixing compressed air with an ammonia gas stream, to produce an ammonia/oxygen-containing gas mixture;
an ammonia converter, for oxidising ammonia in the ammonia/oxygen-containing gas mixture, to produce a NOₓ gas/steam mixture comprising water and nitric oxide;
a gas cooler/condenserdownstream the ammonia converter, to produce an aqueous diluted nitric acid mixture and a gaseous NOₓ stream;
an absorption tower, downstream the gas cooler/condenser, for absorbing the NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas; and
a tail gas heater, positioned upstream from the gas cooler/condenser, for heating a tail gas stream with the heat from the NOₓ gas/steam mixture coming from the ammonia converter;
   into a production plant according to any one of claims 1 to 7, the revamping method comprising the steps of:
introducing a supply for an oxygen-rich gas, such as a high pressure water electrolyzer, the oxygen-rich gas being in fluid communication with compressed air, the mixing of the oxygen-rich gas and of compressed air providing part of a first oxygen-containing gas;
introducing a supply for second oxygen-containing gas, for supplying oxygen between the ammonia converter and the absorption tower, such that a tail gas stream contains at least 0.5% by volume oxygen;
introducing a means for regulating the concentration of oxygen in the ammonia converter and/or of the ammonia gas stream, particularly a means for controlling the flow of the oxygen-rich gas and/or a means for controlling the flow of the ammonia gas stream, for maintaining the oxygen to ammonia molar ratio inside the ammonia converter at a ratio of at least 1.2, in particular between 1.2 and 9;
introducing a first means for splitting and/or a second means for splitting a tail gas stream, wherein:
   (i) the first means of splitting is configured to split a tail gas stream into a first tail gas stream and a second tail gas stream, and wherein the first tail gas stream is in fluid communication with the oxygen-rich gas and compressed air, thereby providing the first oxygen-containing gas; and
   (ii) the second means of splitting is configured to split a tail gas stream into a third tail gas stream and a fourth tail gas stream, and wherein the third tail gas stream is in fluid communication with the oxygen-rich gas and compressed air, thereby providing at least partly the second oxygen-containing gas; and
introducing a means for pressurizing a gas to a pressure P1 downstream the absorption tower, or between the ammonia converter and the absorption tower, or in the first oxygen-containing stream or in the ammonia/oxygen-containing gas mixture, such as to provide the first and/or the third tail gas stream at a pressure P1.

### BRIEF DESCRIPTION OF THE FIGURES

FIG. 1: Nitric acid plant according to the prior art

FIG. 2: Nitric acid plant according to an embodiment of the present application

FIG. 3: Nitric acid plant according to an embodiment of the present application comprising a bleacher (57)

Table of numerals

| | |
|---|---|
| 4 | air |
| 5 | tail gas |
| 6 | outlet of nitric acid absorption tower |
| 7 | tail gas expander |
| 14 | ammonia/oxygen-enriched air mixture |
| 15 | NOₓ gas/steam mixture |
| 17 | aqueous diluted nitric acid mixture |
| 22 | gaseous NOₓ stream |
| 27 | stream of raw nitric acid containing residual NOₓ gas |
| 32 | ammonia |
| 34 | compressed air |
| 35 | mixing apparatus |
| 36 | air compressor |
| 37 | ammonia converter operable at a pressure P1 |
| 38 | gas cooler/condenser |
| 39 | cooler/separator |
| 41 | absorption tower |
| 43 | tail gas heater |
| 50 | oxygen-rich gas |
| 51 | steam turbine |
| 52 | first tail gas stream |
| 53 | means for pressurizing a tail gas stream |
| 55 | first means for splitting a stream of tail gas |
| 56 | first oxygen-containing gas |
| 57 | bleacher |
| 58 | bleacher inlet for bleaching gas 60 |
| 59 | bleacher outlet for bleached nitric acid 63 |
| 60 | oxygen-rich gas bleaching gas |
| 61 | off-gases out of the bleacher 57 |
| 63 | bleached nitric acid |
| 64 | bleacher inlet for raw nitric acid containing residual NOₓ gas 27 |
| 65 | bleacher outlet for off-gases 61 |
| 66 | pressurized water electrolyzer |
| 67 | second oxygen-containing gas |
| 70 | expanded tail gas |
| 71 | De-NOₓ treatment unit |
| 73 | heat exchanger |
| 74 | second tail gas stream |
| 75 | second means for splitting |
| 76 | third tail gas stream |
| 77 | fourth tail gas stream |

### DETAILED DESCRIPTION

Throughout the description and claims of this specification, the words “comprise” and variations thereof mean “including but not limited to”, and they are not intended to (and do not) exclude other moieties, additives, components, integers or steps. Throughout the description and claims of this disclosure, the singular encompasses the plural unless the context otherwise requires. In particular, where the indefinite article is used, the disclosure is to be understood as contemplating plurality as well as singularity, unless the context requires otherwise.

Features, integers, characteristics, compounds, chemical moieties, or groups described in conjunction with a particular aspect, embodiment or example of the disclosure are to be understood to be applicable to any other aspect, embodiment or example described herein unless incompatible therewith. All of the features disclosed in this disclosure (including the description, claims, abstract and drawing), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this disclosure (including the description, claims, abstract and drawing), or to any novel one, or any novel combination, of the steps of any method or process so disclosed.

The enumeration of numeric values by means of ranges of figures comprises all values and fractions in these ranges, as well as the cited end points. The terms “ranging from . . . to . . . ” or “range from . . . to . . . ” or “up to” as used when referring to a range for a measurable value, such as a parameter, an amount, a time period, and the like, is intended to include the limits associated to the range that is disclosed.

Where the term “about” when applied to a particular value or to a range, the value or range is interpreted as being as accurate as the method used to measure it.

The present disclosure generally relates to a system and method for the production of nitric acid, particularly in a mono pressure production plant, with important gains compared to conventional systems and methods, wherein the conventional primary air and/or secondary air consisting of pressurized air is partially replaced by the combination of (i) oxygen gas or an oxygen-rich gas, in particular a pressurized oxygen gas or oxygen-rich gas, such as produced by a high-pressure water electrolyzer as further discussed herein; and (ii) a recirculated tail gas stream. Stated differently, in the system and methods for the production of nitric acid according to the present disclosure:
(i) oxygen gas or an oxygen-rich gas, in particular a pressurized oxygen gas or oxygen-rich gas, such as produced by a high-pressure water electrolyzer, is (a) mixed with the compressed air and, in particular, with part of the tail gas stream, to provide a first oxygen-containing gas stream, which is mixed with an ammonia gas stream and subsequently provided to the ammonia converter, and (b) is used to provide a second oxygen-containing gas stream downstream of the ammonia convertor, such as a second oxygen-containing gas stream which is mixed with a NOₓ containing gas stream downstream of the ammonia convertor, such as in an oxidation section and/or upstream of the absorber, and/or which is used as a stripping gas in a bleacher, wherein, in particular, the oxygen containing bleacher off-gases are subsequently mixed with a NOₓ containing gas stream downstream of the ammonia convertor and upstream of the absorber; and
(ii) the tail gas exiting the absorber is split in a first tail gas stream and a second tail gas stream and/or a third and a fourth tail gas stream, wherein the first tail gas stream is mixed with oxygen gas or the oxygen-rich gas, in particular the pressurized oxygen gas or oxygen-rich gas, such as produced by a high-pressure water electrolyzer, and with the pressurized air, to provide the first oxygen-containing gas stream; and/or wherein part of the tail gas exiting the absorber, in particular the third tail gas stream, may also be mixed with the oxygen gas or oxygen-rich gas, in particular the pressurized oxygen gas or oxygen-rich gas, such as produced by a high-pressure water electrolyzer, to provide the second oxygen-containing gas stream.

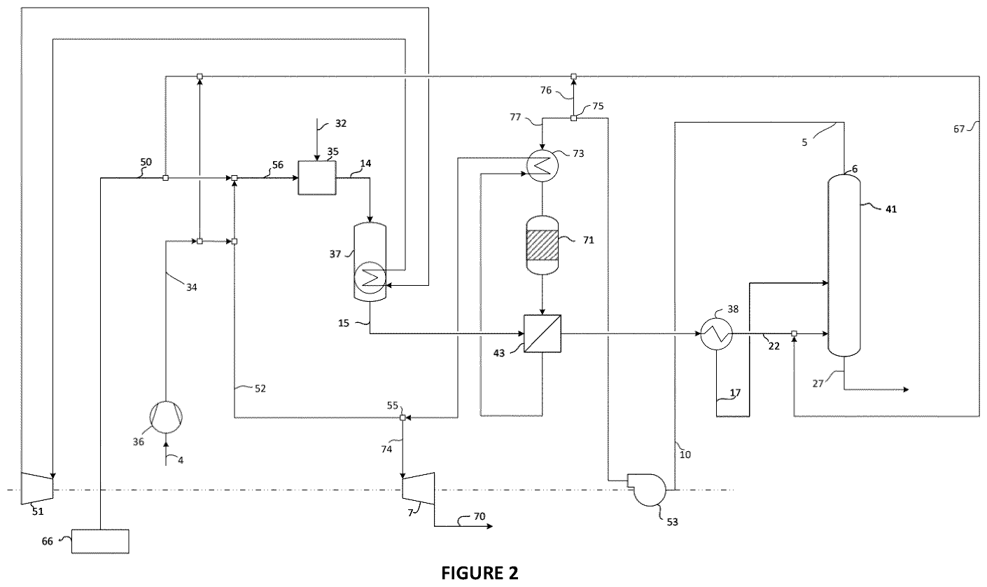

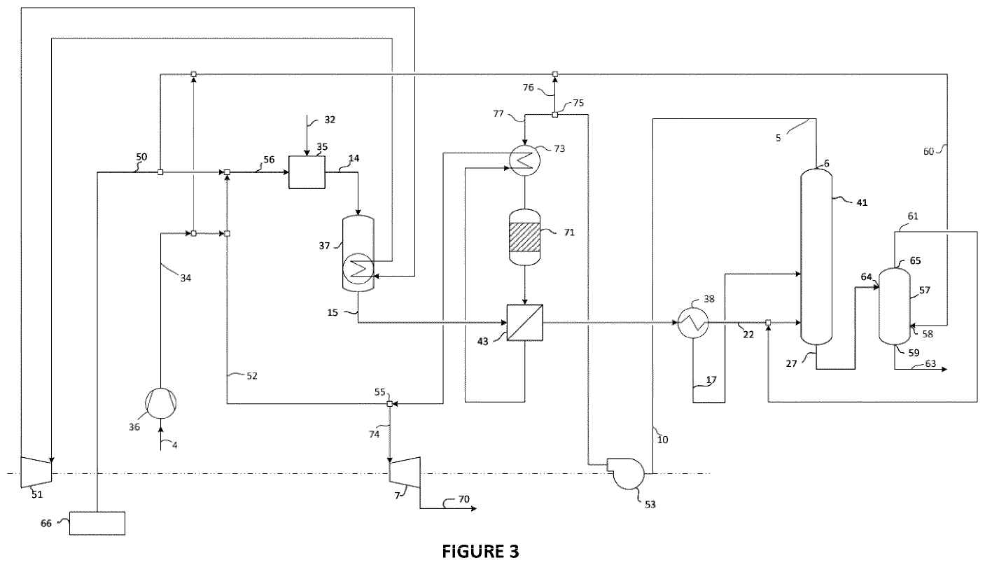

Mono pressure production plant for producing nitric acid Reference is made to FIGS. 2 and 3. In one aspect of the disclosure, a production plant for producing nitric acid at reduced power consumption and reduced emissions is disclosed. The production plant comprises an air compressor 36 providing compressed air 34; a supply for an oxygen-rich gas 50, the oxygen-rich gas 50 being in fluid communication with compressed air 34, the mixing of the oxygen-rich gas 50 and of compressed air 34 providing part of a first oxygen-containing gas 56; a mixing apparatus 35, for mixing the first oxygen-containing gas 56 with an ammonia gas stream 32, to produce an ammonia/oxygen-containing gas mixture 14; an ammonia converter 37 operable at a pressure P1, for oxidising ammonia in the ammonia/oxygen-containing gas mixture 14, to produce a NOₓ gas/steam mixture 15 comprising water and nitric oxide; a means for regulating (not shown) the concentration of ammonia and/or of oxygen in the ammonia converter 37, particularly a means for controlling the flow of the oxygen-rich gas 50 and/or a means for controlling the flow of the ammonia gas stream 32, for maintaining the oxygen to ammonia molar ratio inside the ammonia converter 37 at a ratio of at least 1.2, in particular between 1.2 and 9; a gas cooler/condenser 38 downstream the ammonia converter 37, to produce an aqueous diluted nitric acid mixture 17 and a gaseous NOₓ stream 22; an absorption tower 41, downstream the gas cooler/condenser 38, for absorbing the NOₓ gases from the gaseous NOₓ stream 22 in water, to produce a stream of raw nitric acid containing residual NOₓ gas 27 and a tail gas 5 comprising NOₓ gases, comprising an absorption tower tail gas outlet 6 for evacuating the tail gas 5; and a supply for a second oxygen-containing gas 60, 61, 67, for supplying oxygen to a NOₓ gas containing stream between the ammonia converter 37 and the absorption tower 41, such that a tail gas stream 5, 52, 74, 76, 77 contains at least 0.5% by volume oxygen; a tail gas heater 43, positioned upstream from the gas cooler/condenser 38, for heating a tail gas stream with the heat from the NOₓ gas/steam mixture 15 coming from the ammonia converter 37.

The production plant is characterized in that it further comprises a first and/or second means for splitting a gas stream wherein (i) the first means for splitting 55 is a means for splitting a tail gas stream into a first tail gas stream 52 and a second tail gas stream 74, wherein the first tail gas stream 52 is in fluid communication with the oxygen-rich gas 50 and compressed air 34, and wherein the mixing of compressed air 34, the first oxygen-rich gas 50 and the first tail gas stream 52 provides the first oxygen-containing gas 56; and (ii) the second means for splitting 75 is a means for splitting a tail gas stream 5 into a third tail gas stream 76 and a fourth tail gas stream 77, and wherein the third tail gas stream 76 is in fluid communication with compressed air 34 and with the oxygen-rich gas 50, and the mixing of compressed air 34, the oxygen-rich gas 50 and wherein the third tail gas stream 76 provides at least partly the second oxygen-containing gas 60, 61, 67; and a means for pressurizing 53 a gas, located downstream the absorption tower 41, or between the ammonia converter 37 and the absorption tower 41, or upstream the ammonia converter 37 in the first oxygen-containing gas 56 or in the ammonia/oxygen-containing gas mixture 14, to provide the first and/or the third tail gas stream 52, 76 at a pressure P1.

As defined herein, an oxygen-rich gas is a gas comprising more than 21 vol % of oxygen, more in particular more than 30 vol %, more than 35 vol %, more than 40 vol %, more than 50 vol %, more than 60 vol %, more than 70 vol %, more than 80 vol %, more than 90 vol %, more than 95 vol %, more than 98 vol % and more than 99 vol %, more in particular 100 vol % of oxygen. An oxygen-rich gas can, for example, be provided by an air separation unit or by a water electrolyzer.

As defined herein, steam is water vapors. As defined herein, the term flow refers to either a volumetric flow or a mass flow.

As defined herein, an air compressor is capable of providing at least 300000 m³/h of compressed air.

As defined herein a tail gas heater is a heat exchange system comprising one or more heat exchanger units. In the case the heat exchanger is made of multiple heat exchanger units, the person skilled in the art will realize that it is possible to split the tail gas stream downstream the absorption tower 41 inside the tail gas heater 43.

As defined herein, a tail gas stream is any gas stream provided downstream the absorption tower, between the absorption tower 41 and the communication between the first tail gas stream 52 and the oxygen-rich gas 50.

As defined herein, a means for splitting is any means suitable for splitting a tail gas stream such as to generate e.g. a first tail gas stream 52 and a second tail gas stream 74, or a third tail gas stream 76 and a fourth tail gas stream 77. In particular, the means for splitting is a T-connection having one inlet and two outlets, such that a gas flowing through the inlet of the T-connection is split into two gas streams of identical chemical composition.

As defined herein, a means for pressurizing is any suitable means for increasing the pressure of a gas stream. In particular, the means for pressurizing is a gas compressor or a gas ejector. The person skilled in the art will realize that the means for splitting can be incorporated inside the means for pressurizing, provided that the means for pressurizing includes at least two outlets for the gas stream being pressurized.

As defined herein, a means for regulating the concentration of ammonia and/or of oxygen is any means for suitable for achieving a target concentration of ammonia and/or of oxygen. In particular, such means are gas flow control means, in particular a flow control valve or an orifice or a guide vane, for controlling the flow of the oxygen-rich gas 50 and/or of the ammonia gas stream 32. In particular, the means is an integrated process control system, in which the concentration of oxygen is measured and the target flow of oxygen is thereby determined and achieved from controlling the flow of the oxygen-rich gas 50. The oxygen concentration can also be determined from computing, by using the oxygen concentration of the oxygen-rich gas 50, the flow at which the oxygen-rich gas 50 and of the ammonia gas stream 32 are introduced in the system, and the relative flow values at which the oxygen-rich gas 50 and the ammonia gas stream 32 are mixed.

Typically, P1 ranges from 2 to 16 bara. The person skilled in the art will determine the optimal concentrations of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. The person skilled in the art will also weigh out the benefits of increasing the oxygen content in the absorption tower 41, namely a reduced tower size due to improved absorption, against the drawback of a higher gas volume downstream the absorption tower 41, which implies equipment, such as heat exchangers, of a larger size, for heating tail gas.

The inventors have found that, instead of supplying primary and secondary air solely as compressed air 34 provided by an air compressor 36, it is possible to recirculate the first tail gas stream 52 and/or the third tail gas stream 76, provided by the first means for splitting 55 and the second means for splitting 75, respectively. The oxygen-rich gas 50 having a pressure P1 and the second oxygen-containing gas 67 provide oxygen to the ammonia converter 37 and to the absorption tower 41, respectively, such that, even at reduced amounts of compressed air 34 air provided by the air compressor 36, the concentration of oxygen in the ammonia converter 37 and in the absorption tower 41 is at least equal to that in a state-of-the-art mono pressure nitric acid plant. The separate supply of high pressure oxygen or oxygen-rich gas thus ensures that the oxygen and ammonia concentrations in the ammonia converter allow for the production of nitric acid of a commercial grade. The person skilled in the art will realize that, if the pressure of the oxygen-rich gas 50 is lower than P1, or at a pressure such that the pressure of the first oxygen-containing gas 56 is, the relevant pressure drop being accounted for, lower than the operating pressure of the ammonia converter 37, the oxygen-rich gas 50 can be compressed through the air compressor 36. The fluid communication between compressed air and the oxygen-rich gas 50 is then introduced inside the air compressor 36.

Therefore, tail gas can be recirculated both as primary and secondary air. Consequently, less compressed air 34 is to be supplied such that less air has to be compressed and the power demand on the air compressor 34 is reduced. At the same time, the size of the air compressor 36 and that of a conventional gas expander 7, in which the tail gas 5 is expanded in a state-of-the-art mono pressure nitric acid plant, are reduced, such that the footprint of the plant is reduced. Furthermore, the NOₓ emissions leaving the production plant are also reduced. Consequently, the size of the treatment unit for treating those NOx emissions is reduced with respect to the size in the corresponding state-of-the art mono pressure nitric acid plant.

In one embodiment according to the production plant of the disclosure, the production plant further comprises a means for controlling the flow of the first and/or the third tail gas stream 52, 76.

As defined herein, means for controlling the flow of the first and/or the third tail gas stream 52, 76 is any means for respectively controlling the splitting in the first means for splitting 55 and/or the second means for splitting 75. In particular, the first means for splitting 55 and/or the second means for splitting 76 is a T-connection as described above and the means for controlling is an orifice or a guide vane or a flow control valve at one or both of the outlets of the T-connection.

The control of the flow of the first tail gas 52 enables to retain further control on the pressure and temperature inside the ammonia converter 37. Similarly, control of the flow of the third tail gas 76 enables to retain further control on the pressure and temperature inside the absorption tower 41.

In one embodiment according to the production plant of the disclosure, the production plant further comprises one or more of a heat exchanger 73, for exchanging heat between a tail gas stream 77 downstream the absorption tower 41 and the stream of heated tail gas exiting the tail gas heater 43, wherein (i) the tail gas stream having exchanged heat with the stream of heated tail gas is supplied to the first means for splitting 55 downstream the heat exchanger 73, and wherein the means for pressurizing 53 are located upstream the heat exchanger 73; and/or (ii) the tail gas 5 at the outlet 6 of the absorption tower 41 is split into a third tail gas stream 76 and a fourth tail gas stream 77; a De-NOₓ treatment unit 71; and a steam turbine 51, wherein the steam turbine can at least partly power the means for pressurizing 53. In particular, the production plant further comprises one or more of a heat exchanger 73, for exchanging heat between a heated tail gas stream 77 downstream the tail gas heater 43 and a stream of tail gas upstream the tail gas heater 43, wherein (i) the tail gas stream downstream of the tail gas heater 43 and having exchanged heat with the stream of tail gas upstream the tail gas heater 43, is in direct fluid communication with the first means for splitting 55, and wherein the means for pressurizing 53 is located upstream the heat exchanger 73; and/or (ii) the tail gas 5 at the outlet 6 of the absorption tower 41 is split into the third tail gas stream 76 and the fourth tail gas stream 77; a De-NOₓ treatment unit 71; and a steam turbine 51, wherein the steam turbine can at least partly power the means for pressurizing 53.

As defined herein, means for converting steam into power are any means for achieving power from steam. In particular, those means are a steam turbine connected to an electric generator.

Advantageously, the first means for splitting 55 and/or the second means for splitting 75 is located downstream the tail gas heater 43. Indeed, both the first tail gas stream 52 and the second tail gas stream 74 are then at an optimal temperature. This means that the first tail gas stream 52 is at a temperature below 300° C., such that the first tail gas stream 52 can be fed to the ammonia converter 37 without the amount of ammonia fed through the stream 32 having to be adjusted, in order to maintain the temperature at which the ammonia converter 37 is operable. Typically, the ammonia converter is operated at a temperature ranging from 800 to 950° C. In addition, the location of the first means for splitting 55 downstream the tail gas heater 43 confers to the second tail gas stream 74 an optimal temperature for being expanded such as to provide an optimum of energy which can be used to power, at least partly, the air compressor 36 or the means for pressurizing 53.

Further, the presence of a steam turbine 51 allows for the recovery of the heat of the steam produced in the ammonia converter 37 and this recovered heat can be used, at least partly, for powering the air compressor 36 or the means for pressurizing 53.

In addition, the location of the means for pressurizing 53 upstream the heat exchanger 73 contribute to operating the production plant in an energy-efficient manner. Indeed, less power is required for the means for pressurizing 53 to pressurize a tail gas stream before it is heated by the heat exchanger 73.

In particular, the tail gas 5 exiting the outlet 6 of the absorption tower 41 is heated in the heat exchanger 73 from a temperature ranging from 20 to 250° C., to a temperature ranging from 100 to 450° C. Subsequently, the tail gas exiting the heat exchanger 73 is heated in the tail gas heater 43 to a temperature ranging from 200 to 550° C. The tail gas exiting the heat exchanger 73 then is at an optimal temperature for being treated in the De-NOₓ treatment unit 71 and, therefore, the De-NOₓ treatment unit 71 is located between the heat exchanger 73 and the tail gas heater 43. The person skilled in the art will, without any difficulty, select the proper location for the De-NOₓ treatment unit 71 such that the operating temperature of the De-NOₓ treatment unit 71 is in agreement with the temperature of the corresponding tail gas stream. In the presence of a De-NOₓ treatment unit 71, the NOₓ emissions leaving the production plant through the second tail gas stream 74 are reduced.

In particular, part of the tail gas 5, that is the second tail gas stream 76 provided by the second means for splitting 75, can be recirculated to a point between the ammonia converter 37 and the absorption tower 41, which reduces the duty on secondary air to be provided by the air compressor 36.

In one embodiment according to the production plant of the disclosure, the production plant further comprises a bleacher 57 comprising an inlet 58 for an oxygen-rich bleaching gas 60, an inlet 64 for the stream of raw nitric acid containing residual NOₓ gas 27, an outlet 59 for bleached nitric acid 63 and an outlet 65 for off-gases 61, wherein the off-gases 61 are in fluid communication with a gas stream between the ammonia converter 37 and the absorption tower 41, such that the second oxygen-containing gas 67 comes at least partly from the off-gases 60, 61. In this way, an efficient use of an oxygen-rich bleaching gas is made to increase the oxygen content in the absorption tower 41, thereby increasing the absorption of the NOₓ gases and reducing the corresponding emissions to air. In particular, the oxygen-rich bleaching gas 60 is provided by a high pressure water electrolyzer 66: as less energy is required to pressurize water than to pressurize oxygen gas, pressurized oxygen gas is obtained at minimum power consumption.

The person skilled in the art will understand that the pressure of the bleaching gases 61 is to be adjusted to about P1 before they are mixed with the gaseous NOₓ stream 22. When the stream of raw nitric acid containing residual NOₓ gas 27 is bleached, the amounts of NOₓ gases and nitrous acid HNO₂ in the nitric acid solution are reduced. This in turn results in less brown fumes coming out of the nitric acid solution. In addition, the nitric acid solution provided by the bleacher is of a higher quality, that is purer.

Conveniently, when the stream of raw nitric acid containing residual NOₓ gas 27 is bleached, the supply of the second oxygen-containing gas 67 is achieved through the oxygen-rich bleaching gas 60 and, in turn, through the bleacher 57 and the off-gases 61.

In one embodiment according to the production plant of the disclosure, the oxygen-rich gas 50, the second oxygen-containing gas 67, the oxygen-rich bleaching gas 60 and the oxygen-rich off-gases 61 are provided at least partly by a high-pressure water electrolyzer 66. Stated differently, in particular embodiments, the system of the present disclosure comprises a high-pressure water electrolyzer, wherein the high-pressure water electrolyzer, in particular its anode, is in fluid communication with the compressed air stream, to provide an oxygen-rich gas/compressed air stream mixture.

A water electrolyzer is a device for the electrolysis of water, being the decomposition of water into oxygen and hydrogen gas, due to the passage of an electric current therethrough. This technique can be used to make hydrogen gas, a main component of hydrogen fuel, and oxygen gas. A suitable high-pressure water electrolyzer may comprise an anode producing oxygen gas according to the reaction

2 OH—=H₂O+½O₂+2 e−;

a cathode, producing hydrogen gas according to the reaction

2H₂O+2 e−=H₂+2OH—;

an electrolyte consisting of an alkaline solution such as potassium hydroxide; and a porous diaphragm separating the anode and the cathode, in order to avoid the mixing of hydrogen gas and oxygen gas that together form an explosive mixture. Alternatively, the anode and the cathode may be separated by a solid polymer electrolyte such as the fluoropolymer Nafion, where the electrolyte provides the selective transport of protons from the anode to the cathode, as well as the electrical insulation between the anode and the cathode, and avoids the mixing of hydrogen gas and oxygen gas that together form an explosive mixture.

The anode and cathode can be made of nickel or steel, or mixtures thereof. Alternatively, for the purpose of enhancing the electrode reactions, the anode and cathode may contain catalysts that can be made of Iridium and Platinum, respectively. The diaphragm of an electrically insulating material is based on, for example, zirconia. The diaphragm has a porosity such that it forms a barrier against transport of hydrogen and oxygen gas bubbles, while containing a continuum of penetrated liquid electrolyte. An anode-diaphragm-cathode assembly constitutes an electrolysis cell. Electrolysis cells are piled in series in stacks that compose the core of an electrolyzer. The hydrogen and oxygen production for a given stack volume is proportional to the current density and inversely proportional to the stacking distance. Regardless of stack volume, the hydrogen and oxygen production is proportional to the total current. In addition to the stack, the electrolyzer comprises auxiliaries such as a current rectifier, a water demineralization unit, a water pump and a cooling system, a hydrogen purification unit, and instrumentation.

The electrolyzer is operated by applying a voltage corresponding to the state-of-the-art potential plus the overpotential over each cell. The total voltage depends on the total number of cells of which the electrolyzer is comprised. OH— ions generated at the cathode migrate through the electrolyte in the diaphragm to the anode, where they are consumed by the anode reaction. Electrons travel the opposite direction in an external circuit. A high-pressure water electrolyzer is operated at a pressure higher than P1, in particular higher than 2 bara, in particular as a high pressure electrolyzer at a high pressure of 9 to 30 bara, more in particular 15 to 30 bara and may be operated at a temperature of 50 to 80° C., or 60 to 80° C.

A high-pressure water electrolyzer hence results in the production of pressurized hydrogen at the cathode and pressurized oxygen at the anode, the produced oxygen and hydrogen gases having a higher pressure than atmospheric pressure. What is required to perform high-pressure electrolysis is to pressurize the water used in the electrolysis process. As pressurizing water requires less power than pressuring a gas, the use of a high-pressure water electrolyzer results in the production of pressurized oxygen-rich gas at minimized power consumption.

Conveniently, the high-pressure water electrolyzer 66 provides oxygen to all the various points in the production plant where oxygen needs to be fed. In particular, the supply of oxygen from the electrolyzer 66 is sufficient to provide all of the oxygen of the oxygen-rich gas 50, the second oxygen-containing gas 67, the oxygen-rich bleaching gas 60 and the oxygen-rich off-gases 61. In this manner, the system is simplified and can comprise a single source of oxygen from which oxygen-containing gas streams at the desired pressure, following standard pressure adjustment, can be produced. In addition, supplying additional pressurized oxygen-rich gas upstream the absorption tower improves the absorption of NOₓ gases in the absorption tower, which, in its turn, results in additional nitric acid production and reduction of the emissions to the atmosphere. In addition, or alternatively, the size of the absorption tower can be reduced.

Another advantage of the presence of a high-pressure water electrolyzer lies in the potential to, in parallel to producing oxygen gas that can be used in nitric acid production, also produce hydrogen gas. Such hydrogen gas is produced in a green manner, that is without the conventional use of natural gas which results in the production of the green-house gas carbon dioxide, CO₂. The hydrogen gas can then be used in the production of ammonia in a Haber-Bosch or also conventionally named synthesis gas unit. The high-pressure water electrolyzer then enables the integration of the ammonia and nitric acid production processes.

In one embodiment according to the production plant of the disclosure, the production plant further comprises a tail gas expander 7 for expanding the second tail gas stream 74 to atmospheric pressure, to produce an expanded tail gas 70, wherein the means for pressurizing 53 can be powered at least partly by the tail gas expander 7 or by the steam turbine 51 or by a power source.

In the presence of such tail gas expander 7, the second tail gas stream 74 can be expanded, thereby providing power that can be used, at least partly, for operating the means for pressurizing 53, and for operating the air compressor 36.

### Method for Producing Nitric Acid

In one aspect of the disclosure, a method for producing nitric acid at reduced power consumption and reduced emissions, in a production plant according to the production plant of the disclosure is disclosed. The method comprises the steps of a) compressing air in the air compressor 36, thereby providing compressed air 34; b) supplying compressed air 34 obtained in step a) to the mixing apparatus 35; c) supplying the ammonia gas stream 32 to the mixing apparatus 35, thereby producing the ammonia/oxygen-containing gas mixture 14; d) oxidising ammonia in the ammonia/oxygen-containing gas mixture 14 in the ammonia converter 37 at a pressure P1, thereby producing the gaseous NOₓ gas/steam mixture 15 comprising water and nitric oxide; e) separating and condensing steam in the gas cooler/condenser 38, thereby generating the aqueous diluted nitric acid mixture 17 and the gaseous NOₓ stream 22; f) absorbing the gaseous NOₓ stream 22 in the absorption tower 41, thereby producing the stream of raw nitric acid containing residual NOₓ gas 27 and the tail gas 5 comprising NOₓ gases; and g) heating the tail gas 5 in the tail gas heater 43 to a temperature up to 650° C. with the gaseous NOₓ gas/steam mixture 15.

The method is characterized in that it further comprises the steps of h) pressurizing a gas stream located downstream the absorption tower 41, or anywhere between the ammonia converter 37 and the absorption tower 41, or upstream the ammonia converter 37 in the first oxygen-containing stream 56 or in the ammonia/oxygen-containing gas mixture 14, to a pressure P1 with the means for pressurizing 53; i) splitting a stream of tail gas downstream the absorption tower 41 with the first means for splitting into the first tail gas stream 52 and the second tail gas stream 74 and/or with the second means for splitting into the third tail gas stream 76 and the fourth tail gas stream 77; j) mixing the first tail gas stream 52 with the oxygen-rich gas 50 and compressed air 34, thereby providing the first oxygen-containing gas 56, and/or mixing the third tail gas stream 76 with the oxygen-rich gas 50 and compressed air 34, thereby providing at least partly the second oxygen-containing gas 60, 61, 67; k) adjusting the flow of the oxygen-rich gas 50 being mixed in step j) or the flow of the ammonia gas stream 32, in step c), such as to maintain the oxygen to ammonia molar ratio inside the ammonia converter 37 at a ratio of at least 1.2, in particular between 1.2 and 9; I) supplying the first oxygen-containing gas 56 to the mixing unit 35; m) adjusting the flow of the second oxygen-containing gas 60, 67, such that a tail gas stream 5, 52, 74, 76, 77 contains at least 0.5% by volume oxygen; and n) supplying the second oxygen-containing gas 60, 61, 67.

Typically, P1 ranges from 2 to 16 bara. The person skilled in the art will determine the optimal concentrations of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. The person skilled in the art will also weigh out the benefits of increasing the oxygen content in the absorption tower 41, namely a reduced tower size due to improved absorption, against the drawback of a higher gas volume downstream the absorption tower 41, which implies equipment, such as heat exchangers, of a larger size, for heating tail gas.

The inventors have found that, instead of supplying primary and secondary air solely as compressed air 34 provided by an air compressor 36, it is possible to recirculate the first tail gas stream 52 and/or the third tail gas stream 76, provided by the first means for splitting 55 and the second means for splitting 75, respectively. The oxygen-rich gas 50 having a pressure P1 and the second oxygen-containing gas 67 provide oxygen to the ammonia converter 37 and to the absorption tower 41, respectively, such that, even at reduced amounts of compressed air 34 air provided by the air compressor 36, the concentration of oxygen in the ammonia converter 37 and in the absorption tower 41 is at least equal to that in a state-of-the-art mono pressure nitric acid plant. The person skilled in the art will realize that if the pressure of the oxygen-rich gas 50 is lower than P1, or at a pressure such that the pressure of the first oxygen-containing gas 56 is, the relevant pressure drop being accounted for, lower than the operating pressure of the ammonia converter 37, the oxygen-rich gas 50 can be compressed through the air compressor 36. The fluid communication between compressed air and the oxygen-rich gas 50 is then introduced inside the air compressor 36.

Therefore, tail gas can be recirculated both as primary and secondary air. Consequently, less compressed air 34 is to be supplied such that less air has to be compressed and the power demand on the air compressor 34 is reduced. At the same time, the size of the air compressor 36 and that of a conventional gas expander 7, in which the tail gas 5 is expanded in a state-of-the-art mono pressure nitric acid plant, are reduced, such that the footprint of the plant is reduced. Furthermore, the NOₓ emissions leaving the production plant are also reduced. Consequently, the size of the treatment unit for treating those NOₓ emissions is reduced with respect to the size in the corresponding state-of-the art mono pressure nitric acid plant.

In one embodiment according to the method of the disclosure, the method further comprises the step of o) adjusting the flow of the first and/or the third tail gas stream 52, 76. The control of the flow of the first tail gas 52 enables to retain further control on the pressure and temperature inside the ammonia converter 37. Similarly, control of the flow of the third tail gas 76 enables to retain further control on the pressure and temperature inside the absorption tower 41.

In one embodiment according to the method of the disclosure, in step h), the tail gas 5 obtained from step f) is pressurized in the means for pressurizing 53, and in step i), the tail gas stream is split into a first tail gas stream 52 and a second tail gas stream 74, particularly wherein step (h) is performed before step i), and the method further comprises the steps of p) after step f) and before step g), heating the tail gas 5 with the tail gas to be split in step i), in the heat exchanger 73, thereby bringing the tail gas to be mixed in step j) to a temperature below 300° C.; q) treating the tail gas in the De-NOₓ treatment unit 71 before step g) and after step p); and r) recovering at least part of the heat energy generated in the ammonia converter 37 in the steam turbine 51.

Advantageously, the first means for splitting 55 is located downstream the tail gas heater 43. Indeed, the first tail gas stream 52 and the second tail gas stream 74 are then at an optimal temperature. This means that the first tail gas stream 52 is at a temperature below 300° C., such that the first tail gas stream 52 can be fed to the ammonia converter 37 without the amount of ammonia fed through the stream 32 having to be adjusted, in order to maintain the temperature at which the ammonia converter 37 is operable. Typically, the ammonia converter is operated at a temperature ranging from 800 to 950° C. In addition, the location of the first means for splitting 55 downstream the tail gas heater 43 confers to the second tail gas stream 74 an optimal temperature for being expanded such as to provide an optimum of energy which can be used to power, at least partly, the air compressor 36 or the means for pressurizing 53.

Further, the presence of a steam turbine 51 allows for the recovery of the heat of the steam produced in the ammonia converter 37 and this recovered heat can be used, at least partly, for powering the air compressor 36 or the means for pressurizing 53.

In addition, the location of the means for pressurizing 53 upstream the heat exchanger 73 contribute to operating the production plant in an energy-efficient manner. Indeed, less power is required for the means for pressurizing 53 to pressurize a tail gas stream before it is heated by the heat exchanger 73.

In particular, the tail gas 5 exiting the outlet 6 of the absorption tower 41 is heated in the heat exchanger 73 from a temperature ranging from 20 to 250° C., to a temperature ranging from 100 to 450° C. Subsequently, the tail gas exiting the heat exchanger 73 is heated in the tail gas heater 43 to a temperature ranging from 200 to 550° C. The tail gas exiting the heat exchanger 73 then is at an optimal temperature for being treated in the De-NOₓ treatment unit 71 and, therefore, the De-NOₓ treatment unit 71 is located between the heat exchanger 73 and the tail gas heater 43. The person skilled in the art will, without any difficulty, select the proper location for the De-NOₓ treatment unit 71 such that the operating temperature of the De-NOₓ treatment unit 71 is in agreement with the temperature of the corresponding tail gas stream. In the presence of a De-NOₓ treatment unit 71, the NOₓ emissions leaving the production plant through the second tail gas stream 74 are reduced.

In one embodiment according to the method of the disclosure, in step h), the tail gas 5 obtained from step f) is pressurized in the means for pressurizing 53, and in step i), the pressurized tail gas obtained from step h) is split into a third tail gas stream 76 and a fourth tail gas stream 77.

In particular, part of the tail gas 5, that is the second tail gas stream 76 provided by the second means for splitting 75, can be recirculated to a point between the ammonia converter 37 and the absorption tower 41, which reduces the duty on secondary air to be provided by the air compressor 36.

In one embodiment according to the method of the disclosure, the method further comprises the step of s) bleaching the stream of raw nitric acid containing residual NOx gas 27 obtained in step f) in the bleacher 57, thereby producing the bleached nitric acid 63. In particular, oxygen-rich gas, such as provided by a high-pressure water electrolyzer may be provided to the bleacher 57 as the bleaching gas 60, thereby generating bleaching off gases 61, which are subsequently mixed with the gaseous NOx stream 22. In this way, an efficient use of an oxygen-rich bleaching gas is made to increase the oxygen content in the absorption tower 41, thereby increasing the absorption of the NOₓ gases in step g) and reducing the corresponding emissions to air. In particular, the oxygen-rich bleaching gas 60 is provided by a high pressure water electrolyzer 66: as less energy is required to pressurize water than to pressurize oxygen gas, pressurized oxygen gas is obtained at minimum power consumption.

The person skilled in the art will understand that the pressure of the bleaching gases 61 is to be adjusted to about P1 before they are mixed with the gaseous NOₓ stream 22. When the stream of raw nitric acid containing residual NOₓ gas 27 is bleached, the amounts of NOₓ gases and nitrous acid HNO₂ in the nitric acid solution are reduced. This in turn results in less brown fumes coming out of the nitric acid solution. In addition, the nitric acid solution provided by the bleacher is of a higher quality, that is purer.

Conveniently, when the stream of raw nitric acid containing residual NOₓ gas 27 is bleached, the supply of the second oxygen-containing gas 67 is achieved through the oxygen-rich bleaching gas 60 and, in turn, through the bleacher 57 and the off-gases 61.

In one embodiment according to the method of the disclosure, the method further comprises the steps of t) operating the high-pressure water electrolyzer 66, such as at a temperature of 50 to 80° C., or 60 to 80° C., and a gas pressure of 9 to 30 bar, preferably 15 to 30 bar, thereby producing pressurized oxygen; and u) providing, from the oxygen produced by the water electrolyzer 66 in step t), at least part of the oxygen-rich gas 50, the second oxygen-containing gas 67, the oxygen-rich bleaching gas 60 and the oxygen-rich off-gases 61. In certain embodiments, the pressurized oxygen or oxygen-rich gas 50 is mixed with the compressed air stream.

Conveniently, the high-pressure water electrolyzer 66 provides oxygen to all the various points in the production plant where oxygen needs to be fed. In particular, the supply of oxygen from the electrolyzer 66 is sufficient to provide all of the oxygen the oxygen-rich gas 50, the second oxygen-containing gas 67, the oxygen-rich bleaching gas 60 and the oxygen-rich off-gases 61. In this manner, the system is simplified and can comprise a single source of oxygen from which oxygen-containing gas streams at the desired pressure, following standard pressure adjustment, can be produced.

Another advantage of the presence of a high-pressure water electrolyzer lies in the potential to, in parallel to producing oxygen gas that can be used in nitric acid production, also produce hydrogen gas. Such hydrogen gas is produced in a green manner, that is without the conventional use of natural gas which results in the production of the green-house gas carbon dioxide, CO₂. The hydrogen gas can then be used in the production of ammonia in a Haber-Bosch or also conventionally named synthesis gas unit. The high-pressure water electrolyzer then enables the integration of the ammonia and nitric acid production processes.

In one embodiment according to the method of the disclosure, the method further comprises the step of v) expanding the second tail gas stream 74 in the tail gas expander 7 to atmospheric pressure, thereby producing the expanded tail gas 70.

In the presence of such tail gas expander 7, the second tail gas stream 74 can be expanded, thereby providing power that can be used, at least partly, for operating the means for pressurizing 53, and for operating the air compressor 36.

### Use of the Production Plant of the Disclosure

In one aspect of the disclosure, the use of the production plant of the disclosure for performing the method of the disclosure, is disclosed.

### Method for Revamping a State-of-the Art Mono Pressure Nitric Acid Production Plant

In one aspect of the disclosure, a method for revamping a production plant for producing nitric acid, comprising an air compressor 36 for providing compressed air 34; a mixing apparatus 35 for mixing compressed air 34 with an ammonia gas stream 32, to produce an ammonia/oxygen-containing gas mixture 14; an ammonia converter 37, for oxidising ammonia in the ammonia/oxygen-containing gas mixture 14, to produce a NOₓ gas/steam mixture 15 comprising water and nitric oxide; a gas cooler/condenser 38 downstream the ammonia converter 37, to produce an aqueous diluted nitric acid mixture 17 and a gaseous NOₓ stream 22; an absorption tower 41, downstream the gas cooler/condenser 38, for absorbing the NOₓ gases from the gaseous NOₓ stream 22 in water, to produce a stream of raw nitric acid containing residual NOₓ gas 27 and a tail gas 5 comprising NOₓ gases, comprising an absorption tower tail gas outlet 6 for evacuating the tail gas 5; and a tail gas heater 43, positioned upstream from the gas cooler/condenser 38, for heating a tail gas stream with the heat from the NOₓ gas/steam mixture 15 coming from the ammonia converter 37; into a production plant according to the production plant of the disclosure, is disclosed.

The method comprises the steps of introducing a supply for an oxygen-rich gas 50, the oxygen-rich gas 50 being in fluid communication with compressed air 34, the mixing of the oxygen-rich gas 50 and of compressed air 34 providing part of a first oxygen-containing gas 56; introducing a supply for second oxygen-containing gas 60, 61, 67, for supplying oxygen between the ammonia converter 37 and the absorption tower 41, such that a tail gas stream 5, 52, 74, 76, 77 contains at least 0.5% by volume oxygen; introducing a means for regulating (not shown) the concentration of oxygen in the ammonia converter 37 and/or of the ammonia gas stream 32, particularly a means for controlling the flow of the oxygen-rich gas 50 and/or a means for controlling the flow of the ammonia gas stream 32, for maintaining the oxygen to ammonia molar ratio inside the ammonia converter 37 at a ratio of at least 1.2; introducing a first means for splitting 55 and/or a second means for splitting 75 a tail gas stream, wherein (i) the first means of splitting 55 is configured to split a tail gas stream into a first tail gas stream 52 and a second tail gas stream 74, and wherein the first tail gas stream is in fluid communication with the oxygen-rich gas 50 and compressed air 34, thereby providing the first oxygen-containing gas 56, and (ii) the second means of splitting 75 is configured to split a tail gas stream into a third tail gas stream 76 and a fourth tail gas stream 77, and wherein the third tail gas stream is in fluid communication with the oxygen-rich gas 50 and compressed air 34, thereby providing at least partly the second oxygen-containing gas 60, 61, 67; and introducing a means for pressurizing 53 a gas to a pressure P1 downstream the absorption tower 41, or between the ammonia converter 37 and the absorption tower 41, or in the first oxygen-containing stream 56 or in the ammonia/oxygen-containing gas mixture 14, such as to provide the first and/or the third tail gas stream 52, 76 at a pressure P1.

As defined herein, an oxygen-rich gas is a gas comprising more than 21 vol % of oxygen, more in particular more than 30 vol %, more than 35 vol %, more than 40 vol %, more than 50 vol %, more than 60 vol %, more than 70 vol %, more than 80 vol %, more than 90 vol %, more than 95 vol %, more than 98 vol % and more than 99 vol %, more in particular 100 vol % of oxygen. An oxygen-rich gas can, for example, be provided by an air separation unit or by a water electrolyzer.

As defined herein, an air compressor is capable of providing at least 300000 m³/h of compressed air.

As defined herein a tail gas heater is a heat exchange system comprising one or more heat exchanger units. In the case the heat exchanger is made of multiple heat exchanger units, the person skilled in the art will realize that it is possible to split the stream of tail gas downstream the absorption tower 41 inside the tail gas heater 43.

As defined herein, a tail gas stream is any gas stream provided downstream the absorption tower, between the absorption tower 41 and the communication between the first tail gas stream 52 and the oxygen-rich gas 50.

As defined herein, a means for splitting is any means suitable for splitting a tail gas stream such as to generate, e.g. a first tail gas stream 52 and a second tail gas stream 74, or a third tail gas stream 76 and a fourth tail gas stream 77. In particular, the means for splitting is a T-connection having one inlet and two outlets, such that a gas flowing through the inlet of the T-connection is split into two gas streams of identical chemical composition.

As defined herein, a means for pressurizing is any suitable means for increasing the pressure of a gas stream. In particular, the means for pressurizing is a gas compressor or a gas ejector. The person skilled in the art will realize that the means for splitting can be incorporated inside the means for pressurizing, provided that the means for pressurizing includes at least two outlets for the gas stream being pressurized.

As defined herein, a means for regulating the concentration of ammonia and/or of oxygen is any means for suitable for achieving a target concentration of ammonia and/or of oxygen. In particular, such means are gas flow control means, in particular a flow control valve or an orifice or a guide vane, for controlling the flow of the oxygen-rich gas 50 and/or of the ammonia gas stream 32. In particular, the means is an integrated process control system, in which the concentration of oxygen is measured and the target flow of oxygen is thereby determined and achieved from controlling the flow of the oxygen-rich gas 50. The oxygen concentration can also be determined from computing, by using the oxygen concentration of the oxygen-rich gas 50, the flow at which the oxygen-rich gas 50 and of the ammonia gas stream 32 are introduced in the system, and the relative flow values at which the oxygen-rich gas 50 and the ammonia gas stream 32 are mixed.

Typically, P1 ranges from 2 to 16 bara. The person skilled in the art will determine the optimal concentrations of oxygen in the gases entering the ammonia converter 37 and the absorption tower 41, in order for the catalytic conversion of ammonia to nitric oxide to proceed optimally in the ammonia converter 37 and for the absorption of NOₓ gases in the absorption tower 41 to proceed optimally. The person skilled in the art will also weigh out the benefits of increasing the oxygen content in the absorption tower 41, namely a reduced tower size due to improved absorption, against the drawback of a higher gas volume downstream the absorption tower 41, which implies equipment, such as heat exchangers, of a larger size, for heating tail gas.

### EXAMPLES

### 1. Recirculation of Tail-Gas at 40%

Reference is made to FIG. 3. Ambient air 4 was compressed in an air compressor 36, providing compressed air 34. Ammonia 32 was mixed with compressed air 34 in a mixing apparatus 35. The oxygen to ammonia molar ratio inside the mixing apparatus 35 was at least 1.2. The resulting ammonia/air mixture 14 was fed to an ammonia converter 37, at a temperature ranging from 800 to 950° C. and operating at a pressure of 6.2 bar. In the ammonia converter 37, ammonia was oxidized over a mixed platinum/rhodium catalyst, thus obtaining a NOₓ gas/steam mixture 15, comprising water and nitric oxide (NO). The heat energy of the mixture coming out of the ammonia converter was recovered using a steam turbine 51, and also by heating the tail gas 5 as will be described below. The NOₓ gas/stream mixture was subsequently cooled down in a water cooler/condenser 38 to temperature where the water condenses, and an aqueous diluted nitric acid mixture 17 was separated from a gaseous NOₓ stream and was directed to an absorption tower 41. Subsequently, the gaseous NOₓ stream was further oxidized to further convert the NO to NO₂ and N₂O₄, thereby producing a gaseous NOₓ stream 22 which was directed to the absorption tower 41 too. Inside the absorption tower 41, the NOₓ gas reacted with water to produce the tail gas 5 and a stream of raw nitric acid 27. The heat from the gaseous NOₓ stream 15 was used for heating the tail gas 5 in the tail gas heater 43 to 450° C., providing a heated tail gas. The heated tail gas stream 5 was then split over a T-tube 55. Following splitting in the T-tube, 40% of the heated tail gas was pressurized using a gas compressor 53 and then mixed with compressed air 34 and an oxygen-rich gas 50. The resulting compressed tail gas 52/oxygen-rich 50/compressed air 34 mixture was mixed with ammonia 32 in the mixing apparatus 35 and the steps subsequent to mixing in the mixing apparatus 35 described above were repeated. The oxygen to ammonia molar ratio inside the mixing apparatus 35 was at least 1.2. The residual 60% of heated tail gas was sent to the tail gas expander 7. The residual NOₓ gas in the raw nitric acid stream 27 was then stripped out with a gaseous medium 60 that was oxygen produced by a water electrolyzer 66, inside a bleacher unit 57. The bleacher unit 57 was generally operated at about the same pressure as the ammonia converter of 6.2 bar and provided the oxygen-rich gas 50 and oxygen between the ammonia converter 37 and the absorption tower 41, such that the concentration of oxygen in the tail gas 5 was at least 0.5% by volume. The drive power for the air compressor 36 and the gas compressor 53 originated from the tail gas expander 7 and the steam turbine 51. The net power associated to the air compressors 36 and 53 and the tail gas expander 7 and the steam turbine 51 was 77 kW/h/t 100% HNO₃. This power was provided by the steam turbine 51.

In a similar manner, upon recycling 65% of the tail gas, the net power associated to the air compressors 36 and 53 and the tail gas expander 7 and the steam turbine 51 was 68 kW/h/t 100% HNO₃.

### 2. Comparative Example: No Recirculation of Tail-Gas

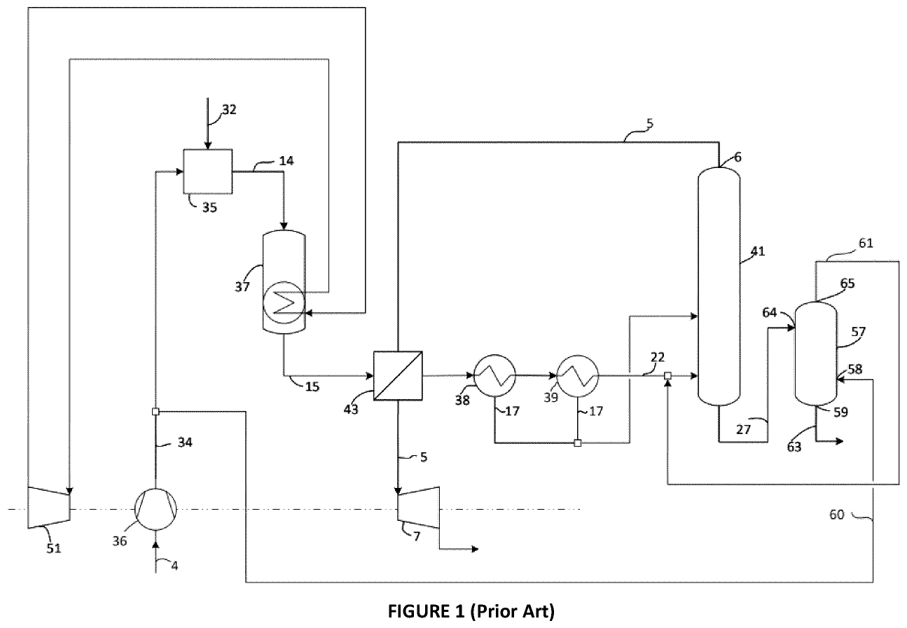

Reference is made to FIG. 1. Ambient air 4 was compressed in an air compressor 36, providing compressed air 34. Ammonia 32 was mixed with compressed air 34 in a mixing apparatus 35. The oxygen to ammonia molar ratio inside the mixing apparatus 35 was at least 1.2. The resulting ammonia/air mixture 14 was fed to an ammonia converter 37, at a temperature ranging from 800 to 950° C. and operating at a pressure of 5.2 bar. In the ammonia converter 37, ammonia was oxidized over a mixed platinum/rhodium catalyst, thus obtaining a NOₓ gas/steam mixture 15, comprising water and nitric oxide (NO). The heat energy of the mixture coming out of the ammonia converter was recovered using a steam turbine 51, and also by heating the tail gas 5 as will be described below. The NOₓ gas/stream mixture was subsequently cooled down in a water cooler/condenser 38 to a temperature where the water condenses, and an aqueous diluted nitric acid mixture 17 was separated from a gaseous NOₓ stream and was directed to an absorption tower 41. Subsequently, the gaseous NOₓ stream was further oxidized to further convert the NO to NO₂ and N₂O₄, thereby producing a gaseous NOx stream 22 which was directed to the absorption tower 41 too. Inside the absorption tower 41, the high pressure NOₓ gas reacted with water to produce the tail gas 5 and a stream of raw nitric acid 27 containing residual NOₓ gas. The heat from the gaseous NOₓ stream 15 was used for heating the tail gas 5 in the tail gas heater 43 to 450° C. The entire tail gas stream 5 was sent to the tail gas expander 7. The residual NOₓ gas in the raw nitric acid stream 27 was then stripped out with compressed air 34 inside a bleacher unit 57 which was generally operated at about the same pressure as the ammonia converter, 5.2 bar. The drive power for the air compressor 36 originated from the tail gas expander 7 and the steam turbine 51. The net power associated to the air compressor 36, and the tail gas expander 7 was 153 kW/h/t 100% HNO₃. This power was produced by the steam turbine 51.

Therefore, when compared to the example 1, a net power of 76 kWh/t 100% HNO₃ (50%) was saved upon recirculating 40% of the tail gas.

Therefore, when compared to the example 1, a net power of 85 kWh/t 100% HNO₃ (55%) was saved upon recirculating 65% of the tail gas.

1. A production plant for producing nitric acid at reduced power consumption and reduced emissions comprising:
an air compressor providing compressed air;
a supply for an oxygen-rich gas, wherein a mixing of the oxygen-rich gas and of compressed air provides part of a first oxygen-containing gas;
a mixing apparatus, for mixing the first oxygen-containing gas with an ammonia gas stream to produce an ammonia/oxygen-containing gas mixture;
an ammonia converter operable at a pressure P1, for oxidising ammonia in the ammonia/oxygen-containing gas mixture, to produce a NOₓ gas/steam mixture comprising water and nitric oxide;
a means for regulating a concentration of ammonia and/or of oxygen in the ammonia converter, including a means for controlling a flow of the oxygen-rich gas and/or a means for controlling a flow of the ammonia gas stream, for maintaining the oxygen to ammonia molar ratio inside the ammonia converter at a ratio of at least 1.2;
a gas cooler/condenser downstream the ammonia converter, to produce an aqueous diluted nitric acid mixture and a gaseous NOₓ stream;
an absorption tower, downstream the gas cooler/condenser, for absorbing NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas; and
a supply for a second oxygen-containing gas, for supplying oxygen to a NOₓ gas containing stream between the ammonia converter and the absorption tower, such that a tail gas stream contains at least 0.5% by volume oxygen;
a tail gas heater, positioned upstream from the gas cooler/condenser, for heating a tail gas stream with the heat from the NOₓ gas/steam mixture coming from the ammonia converter;
characterized in that the production plant further comprises:
a first and/or second means for splitting a gas stream wherein:
(i) the first means for splitting is a means for splitting a tail gas stream into a first tail gas stream and a second tail gas stream, and wherein the first tail gas stream is in fluid communication with the oxygen-rich gas and compressed air, and wherein the mixing of compressed air, the first oxygen-rich gas and the first tail gas stream provides the first oxygen-containing gas; and
(ii) the second means for splitting is a means for splitting a tail gas stream into a third tail gas stream and a fourth tail gas stream, and wherein the third tail gas stream is in fluid communication with compressed air and with the oxygen-rich gas, and wherein the mixing of compressed air, the oxygen-rich gas and the third tail gas stream provides at least partly the second oxygen-containing gas; and
a means for pressurizing a gas, located downstream the absorption tower, or between the ammonia converter and the absorption tower, or upstream the ammonia converter in the first oxygen-containing gas or in the ammonia/oxygen-containing gas mixture, to provide the first and/or the third tail gas stream at a pressure P1.

2. The production plant according to claim 1, further comprising a means for controlling the flow of the first and/or the third tail gas stream.

3. The production plant according to claim 1, further comprising one or more of:
a heat exchanger, for exchanging heat between a heated tail gas stream downstream the tail gas heater and a stream of tail gas upstream the tail gas heater, wherein:
(i) the heated tail gas stream downstream the tail gas heater and having exchanged heat with the stream of tail gas upstream the tail gas heater is in direct fluid communication with the first means for splitting, and wherein the means for pressurizing is located upstream the heat exchanger; and/or
(ii) the tail gas at the outlet of the absorption tower is split into a third tail gas stream and a fourth tail gas stream;
a De-NOₓ treatment unit; and
a steam turbine, wherein the steam turbine can at least partly power the means for pressurizing.

4. The production plant according to claim 1, further comprising a bleacher comprising an inlet for an oxygen-rich bleaching gas, an inlet for the stream of raw nitric acid containing residual NOₓ gas, an outlet for bleached nitric acid and an outlet for off-gases, wherein the off-gases are in fluid communication with a gas stream between the ammonia converter and the absorption tower, such that the second oxygen-containing gas comes at least partly from the off-gases.

5. The production plant according to claim 4, wherein the oxygen-rich gas, the second oxygen-containing gas, the oxygen-rich bleaching gas and the oxygen-rich off-gases are provided at least partly by a high-pressure water electrolyzer.

6. The production plant according to claim 1, further comprising a tail gas expander for expanding the second tail gas stream to atmospheric pressure, to produce an expanded tail gas, wherein the means for pressurizing can be powered at least partly by the tail gas expander or by a steam turbine or by a power source.

7. A method for producing nitric acid at reduced power consumption and reduced emissions, in a production plant according to claim 1, comprising steps of:
a) compressing air in the air compressor, thereby providing compressed air, and providing an oxygen-rich gas;
b) supplying compressed air obtained in step a) and the oxygen-rich gas to the mixing apparatus;
c) supplying the ammonia gas stream to the mixing apparatus, thereby producing the ammonia/oxygen-containing gas mixture;
d) oxidising ammonia in the ammonia/oxygen-containing gas mixture in the ammonia converter at a pressure P1, thereby producing the gaseous NOₓ gas/steam mixture comprising water and nitric oxide;
e) separating and condensing steam in the gas cooler/condenser, thereby generating the aqueous diluted nitric acid mixture and the gaseous NOₓ stream;
f) absorbing the gaseous NOₓ stream in the absorption tower, thereby producing the stream of raw nitric acid containing residual NOₓ gas and the tail gas comprising NOₓ gases; and
g) heating the tail gas in the tail gas heater with the gaseous NOₓ gas/steam mixture; characterized in that the method further comprises the steps of:
h) pressurizing a gas stream located downstream the absorption tower, or anywhere between the ammonia converter and the absorption tower, or upstream the ammonia converter in the first oxygen-containing stream or in the ammonia/oxygen-containing gas mixture, to a pressure P1 with the means for pressurizing;
i) splitting tail gas stream with the first means for splitting into the first tail gas stream and the second tail gas stream and/or with the second means for splitting into the third tail gas stream and the fourth tail gas stream;
j) mixing the first tail gas stream with the oxygen-rich gas and compressed air, thereby providing the first oxygen-containing gas, and/or mixing the third tail gas stream with the oxygen-rich gas and compressed air, thereby providing at least partly the second oxygen-containing gas;
k) adjusting the flow of the oxygen-rich gas being mixed in step j) or the flow of the ammonia gas stream to maintain the oxygen to ammonia molar ratio inside the ammonia converter at a ratio of at least 1.2;
l) supplying the first oxygen-containing gas to the mixing apparatus;
m) adjusting the flow of the second oxygen-containing gas, such that a tail gas stream contains at least 0.5% by volume oxygen; and
n) supplying the second oxygen-containing gas.

8. The method according to claim 7, further comprising the step of:
o) adjusting the flow of the first and/or the third tail gas stream.

9. The method according to claim 7, wherein, in step h), the tail gas obtained from step f) is pressurized in the means for pressurizing, and wherein step h) is performed before step i), and wherein the method further comprises the steps of:
p) after step f) and before step g), heating the tail gas with the tail gas to be split in step i), in a heat exchanger, thereby bringing the tail gas to be mixed in step j) to a temperature below 300° C.;
q) treating the tail gas in a De-NOₓ treatment unit before step g) and after step p); and
r) recovering at least part of a heat energy generated in the ammonia converter in a steam turbine.

10. The method according to claim 7, wherein, in step h), the tail gas obtained from step f) is pressurized in the means for pressurizing, and wherein, in step i), the pressurized tail gas obtained from step h) is split into a third tail gas stream and a fourth tail gas stream.

11. The method according to claim 7, further comprising the step of:
s) bleaching the stream of raw nitric acid containing residual NOₓ gas obtained in step f) in a bleacher, thereby producing a bleached nitric acid.

12. The method according to claim 7, further comprising the steps of:
t) operating a high-pressure water electrolyzer, thereby producing pressurized oxygen; and
u) providing, from the oxygen produced by the water electrolyzer in step t), at least part of the oxygen-rich gas, the second oxygen-containing gas, an oxygen-rich bleaching gas and oxygen-rich off-gases.

13. The method according to claim 7, further comprising the step of:
v) expanding the second tail gas stream in the tail gas expander to atmospheric pressure, thereby producing the expanded tail gas.

14. (canceled)

15. A method for revamping an existing production plant for producing nitric acid, wherein the existing production plant comprises:
an air compressor for providing compressed air;
a mixing apparatus for mixing compressed air with an ammonia gas stream, to produce an ammonia/oxygen-containing gas mixture;
an ammonia converter, for oxidising ammonia in the ammonia/oxygen-containing gas mixture, to produce a NOₓ gas/steam mixture comprising water and nitric oxide;
a gas cooler/condenser downstream the ammonia converter, to produce an aqueous diluted nitric acid mixture and a gaseous NOₓ stream;
an absorption tower, downstream the gas cooler/condenser, for absorbing the NOₓ gases from the gaseous NOₓ stream in water, to produce a stream of raw nitric acid containing residual NOₓ gas and a tail gas comprising NOₓ gases, comprising an absorption tower tail gas outlet for evacuating the tail gas; and
a tail gas heater, positioned upstream from the gas cooler/condenser, for heating a tail gas stream with the heat from the NOₓ gas/steam mixture coming from the ammonia converter;
into a production plant according to claim 1, comprising steps of:
introducing a supply for an oxygen-rich gas, the mixing of the oxygen-rich gas and of compressed air providing part of a first oxygen-containing gas;
introducing a supply for second oxygen-containing gas, for supplying oxygen between the ammonia converter and the absorption tower, such that a tail gas stream contains at least 0.5% by volume oxygen;
introducing a means for regulating the concentration of oxygen in the ammonia converter and/or of the ammonia gas stream, including a means for controlling the flow of the oxygen-rich gas and/or a means for controlling the flow of the ammonia gas stream, for maintaining the oxygen to ammonia molar ratio inside the ammonia converter at a ratio of at least 1.2;
introducing a first means for splitting and/or a second means for splitting a tail gas stream, wherein:
(i) the first means of splitting is configured to split a tail gas stream into afirst tail gas stream and a second tail gas stream, and wherein the first tail gas stream is in fluid communication with the oxygen-rich gas and compressed air, thereby providing the first oxygen-containing gas; and
(ii) the second means of splitting is configured to split a tail gas stream into a third tail gas stream and a fourth tail gas stream, and wherein the third tail gas stream is in fluid communication with the oxygen-rich gas and compressed air, thereby providing at least partly the second oxygen-containing gas; and
introducing a means for pressurizing a gas to a pressure P1 downstream the absorption tower, or between the ammonia converter and the absorption tower, or in the first oxygen-containing stream or in the ammonia/oxygen-containing gas mixture to provide the first and/or the third tail gas stream at a pressure P1.
